(19) United States
(12) Patent Application Publication
(10) Pub. No.: US 2024/0144241 A1
(43) Pub. Date: May 2, 2024

(54) Server and Method

(71) Applicant: TOYOTA JIDOSHA KABUSHIKI KAISHA, Toyota-shi Aichi-ken (JP)

(72) Inventors: Tatsuya OWASHI, Nagoya-shi Aichi-ken (JP); Kuniaki Murakami, Nagoya-shi Aichi-ken (JP); Koji Hetsugi, Toyota-shi Aichi-ken (JP); Tomokazu Ishii, Okazaki-shi Aichi-ken (JP); Naoki Ishihara, Nisshin-shi Aichi-ken (JP)

(73) Assignee: TOYOTA JIDOSHA KABUSHIKI KAISHA, Toyota-shi Aichi-ken (JP)

(21) Appl. No.: 18/494,327

(22) Filed: Oct. 25, 2023

(30) Foreign Application Priority Data
Oct. 28, 2022 (JP) 2022-173438

(51) Int. Cl. G06Q 20/36; G06Q 20/38; G06Q 20/40

(52) U.S. Cl. CPC G06Q 20/36; G06Q 20/389; G06Q 20/401

(57) ABSTRACT

An entity server includes a communication apparatus and a processor. The communication apparatus is configured to receive a temporary use request that requests temporary use of a vehicle by a user, the vehicle being associated with an NFT. When the communication apparatus receives the temporary use request, the processor performs locking processing for locking the NFT.

### CROSS REFERENCE TO RELATED APPLICATIONS

This nonprovisional application is based on Japanese Patent Application No. 2022-173438 filed with the Japan Patent Office on Oct. 28, 2022, the entire contents of which are hereby incorporated by reference.

### BACKGROUND

### Field

The present disclosure relates to a server and a method.

### Description of the Background Art

Japanese Patent Laying-Open No. 2020-027592 discloses a system that manages on a blockchain, right information on assets. This system includes first and second computer systems. The first computer system manages the right information based on a blockchain technology. The second computer system converts the right information into a token. A holder of the token can possess assets corresponding to the token.

### SUMMARY

An object of the present disclosure is to provide a technology that prevents malfunctioning of an NFT.

A server according to the present disclosure includes a communication apparatus and a processor. The communication apparatus is configured to receive a temporary use request that requests temporary use of a tangible object by a holder of a non-fungible token, the tangible object being associated with the non-fungible token. When the communication apparatus receives the temporary use request, the processor performs locking processing for locking the non-fungible token.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing a configuration of an information processing system according to an embodiment.

FIG. 2 is a diagram showing a configuration of a vehicle.

FIG. 3 is a diagram illustrating a data structure of a distributed ledger stored in each node of a public blockchain network.

FIG. 4 is a diagram schematically showing a data structure of a transaction history.

FIG. 5 is a diagram exemplifying a screen shown on a human-machine interface (HMI) apparatus of a user terminal in response to locking processing.

FIGS. 6 and 7 are each a flowchart exemplifying processing performed in connection with minting and sales of an NFT.

FIGS. 8 and 9 are each a flowchart exemplifying processing performed in connection with temporary use of a vehicle by a user.

FIG. 10 is a flowchart showing a specific procedure in temporary use record registration processing.

FIG. 11 is a flowchart exemplifying processing performed by an entity server instead of S729 in FIG. 8.

FIG. 12 is a flowchart exemplifying processing performed by the entity server instead of S775 in FIG. 9.

FIG. 13 is a flowchart exemplifying storage record registration processing performed by the entity server.

### DETAILED DESCRIPTION

An embodiment of the present disclosure will be described in detail below with reference to the drawings. The same or corresponding elements in the drawings have the same reference characters allotted and description thereof will not be repeated. The embodiment and a modification thereof may be combined as appropriate. In the embodiment below, a vehicle is defined as a tangible object by way of example.

A non-fungible token (NFT) has attracted attention as an exemplary token minted based on a distributed ledger technology such as a blockchain technology. The NFT is transferrable, for example, by such exchange as buying and selling in an auction and assignment. Information on the NFT and transfer of the NFT are recorded on a blockchain. Therefore, it is extremely difficult to counterfeit and tamper the NFT.

The NFT can be used as a certificate to certify any right by being associated with a tangible object. The inventors of the subject case have found that a problem as below may arise when the NFT is used as the certificate of right. Specifically, a scene where an NFT is used as a certificate of right to temporarily use a tangible object is assumed. In this scene, when a first user obtains an NFT associated with a tangible object, the first user becomes an NFT holder and acquires the right to temporarily use the corresponding tangible object. This NFT is basically freely transferable. Therefore, while the first user is using the corresponding tangible object, the NFT can be transferred from the first user to a second user. When the NFT is transferred from the first user to the second user while the first user is using the tangible object, the second user becomes the NFT holder whereas the first user may use (possess) the corresponding tangible object. Consequently, such malfunctioning that the first user can unduly use the tangible object in spite of non-possession of the NFT or the second user is unable to use the tangible object in spite of possession of the NFT may be caused.

A server representing an example of the present disclosure includes a communication apparatus and a processor. The communication apparatus is configured to receive from a holder of a non-fungible token, a temporary use request that requests temporary use of a tangible object associated with the non-fungible token. The processor is configured to perform locking processing for locking a subject non-fungible token when the communication apparatus receives the temporary use request.

According to the present disclosure, the non-fungible token (NFT) is locked in response to the temporary use request from the holder. In other words, in response to the temporary use request, the NFT is set to be non-transferable. Such a situation as transfer of the NFT during temporary use of a corresponding tangible object can thus be avoided. Consequently, the malfunctioning (error) of the NFT can be prevented.

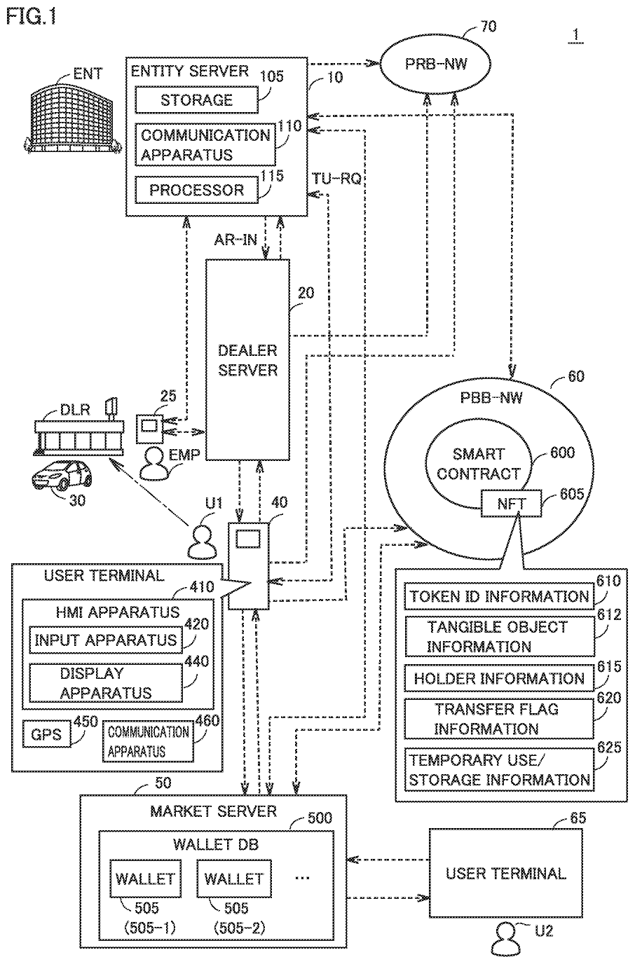

FIG. 1 is a diagram schematically showing a configuration of an information processing system according to an embodiment. Referring to FIG. 1, an information processing system 1 includes an entity server 10, a dealer server 20, a portable terminal 25, a vehicle 30, user terminals 40 and 65, and a market server 50. Information processing system 1 further includes a public blockchain network 60 (specifically, a plurality of nodes thereof) and a private blockchain network 70 (specifically, a plurality of nodes thereof).

Public blockchain network 60 and private blockchain network 70 are denoted as PBB-NW 60 and PRB-NW 70 below, respectively.

Entity server 10 is operated by an entity ENT. Entity ENT is a manufacturing entity that manufactures vehicle 30 and provides various services with the use of the NFT and vehicle 30. The service includes a sales service for sales of vehicle 30 and a temporary use service such as a rental service for rental of vehicle 30, a sharing service for sharing of vehicle 30, or a service for temporary ride on vehicle 30. The service for temporary ride on vehicle 30 is such a service that an owner of vehicle 30 (in this example, a user U1) does not hold vehicle 30 in a garage thereof but has a dealer DLR store vehicle 30 in a garage of dealer DLR, and in such a case, the owner is allowed to bring vehicle 30 out of the garage of dealer DLR and to drive vehicle 30 for some time. The temporary ride service may be provided after vehicle 30 is sold to a purchaser thereof and before vehicle 30 is delivered to the purchaser (owner). Though vehicle is assumed as a specially built limited luxury car in this example, it may be a vehicle for the general public. Entity server 10 includes a storage 105, a communication apparatus 110, and a processor 115.

A program to be executed by processor 115 and data are stored in storage 105. Communication apparatus 110 communicates with a device outside entity server 10 such as dealer server 20, portable terminal 25, user terminal 40, each node on PBB-NW 60, or each node on PRB-NW 70. Entity server 10 is configured to receive from user terminal 40, a temporary use request TU-RQ (which will be described later) that requests temporary use (for example, rental, sharing, or temporary ride) of vehicle 30 by user U1.

Processor 115 includes a central processing unit (CPU) and a memory (neither of which is shown). The memory includes a read-only memory (ROM) and a random access memory (RAM).

Processor 115 performs various types of processing in accordance with the program and the data stored in storage 105. Processor 115 has a smart contract 600 registered on PBB-NW 60, for example, through communication apparatus 110. Smart contract 600 is described by entity ENT. Processor 115 transmits transaction data including smart contract 600 for minting an NFT 605 to PBB-NW 60 through communication apparatus 110. Transmission of transaction data to PBB-NW 60 corresponds to broadcasting of transaction data to nodes on PBB-NW 60. After the transaction data is broadcast, the transaction data is propagated to, taken in, and approved by other nodes on PBB-NW 60.

NFT 605 is associated with vehicle 30 and used as a certificate that certifies a right to temporarily use vehicle 30. NFT 605 is sold to user U1 by entity ENT which is a minter, and possessed by user U1. Entity server 10 transmits an arrangement instruction AR-IN that indicates arrangement of vehicle 30 to dealer server 20 in response to reception of temporary use request TU-RQ. Arrangement of vehicle 30 refers to preparation for ride by the owner of vehicle 30 on vehicle 30 stored in the garage of dealer DLR and includes maintenance and cleaning of vehicle 30.

Dealer server 20 is operated by dealer DLR. Dealer DLR stores and sells vehicle 30. An employee EMP of dealer DLR carries portable terminal 25. Dealer server 20 instructs employee EMP through portable terminal 25 to make arrangements for vehicle 30, in response to arrangement instruction AR-IN. Vehicle 30 is thus maintained and cleaned by employee EMP and thereafter temporarily used by user U1.

User terminal 40 is a terminal apparatus including an HMI apparatus 410, a global positioning system (GPS) receiver 450, and a communication apparatus 460.

HMI apparatus 410 includes an input apparatus 420 and a display apparatus 440. Input apparatus 420 receives input of a user operation by user U1. The user operation includes an operation for generating temporary use request TU-RQ that requests temporary use of vehicle 30 by user U1. This operation is also expressed as a “temporary use request operation.” The user operation includes also an operation for inputting reservation information that should be inputted by user U1 before temporary use of vehicle 30. The reservation information includes temporary use of vehicle 30 by user U1 and information indicating time and day of temporary use of vehicle 30. Display apparatus 440 shows various screens such as a screen (a reservation screen) for reception of input of reservation information.

GPS receiver 450 detects a current position of user terminal 40. While user U1 is on board vehicle 30, a position of user terminal 40 may be used as the position of vehicle 30. Communication apparatus 460 communicates with a device outside user terminal 40 such as entity server 10, dealer server 20, market server 50, each node on PBB-NW 60, and each node on PRB-NW 70. Communication apparatus 460 transmits temporary use request TU-RQ to entity server 10 in response to the temporary use request operation. Communication apparatus 460 may transmit position information indicating the position of user terminal 40 to entity server 10. Communication apparatus 460 may be configured to receive an electronic key (a digital key) for unlocking of a door of vehicle 30 from entity server 10.

Market server 50 functions as a platform that provides an NFT marketplace. This marketplace corresponds to a market used for buying and selling of NFT 605 (putting up and successful bidding). Market server 50 is configured to communicate with each of entity server 10, user terminals 40 and 65, and each node on PBB-NW 60. Market server 50 includes a wallet database (DB) 500. Wallet DB 500 includes a plurality of wallets 505. Wallet 505 is used for each user so as to store NFT 605 or digital assets such as a virtual currency. In this example, wallets 505-1 and 505-2 are used by user U1 and a user U2 (which will be described later), respectively. Since user U1 is an NFT holder in this example, NFT 605 is stored in wallet 505-1. Specifically, a secret key for accessing NFT 605 is stored in wallet 505-1.

Market server 50 can receive a request for putting up NFT 605 from entity server 10. In this case, market server 50 is granted an NFT transfer authority by entity server 10. The NFT transfer authority corresponds to the authority to transfer NFT 605. Since an NFT seller is entity ENT and a successful bidder is user U1 in this example, the NFT transfer authority includes the authority to transfer NFT 605 from entity ENT to user U1. Market server 50 is granted the NFT transfer authority, and thereafter in response to successful bidding of NFT 605, NFT 605 can be transferred from the seller to the successful bidder. Specifically, transfer of NFT 605 refers to transfer of NFT 605 from wallet 505 of the NFT holder to wallet 505 of a trading partner thereof.

User terminal 65 is configured to communicate with market server 50 and used by user U2. User U2 can buy and sell various NFTs through the marketplace provided by market server 50.

PBB-NW 60 is a distributed ledger network accessible by each of entity server 10, user terminal 40, and market server 50. Each of entity server 10, user terminal 40, and market server 50 can refer to and check a distributed ledger stored in a node on PBB-NW 60. Such a distributed ledger includes transaction data on NFT 605. PBB-NW 60 also functions as a platform on which smart contract 600 can be mounted.

Smart contract 600 sets a flag (which will be described later) to 0 when it permits transfer of NFT 605 and sets the flag to 1 when it prohibits transfer of NFT 605.

NFT 605 includes token ID information 610, tangible object information 612, holder information 615, transfer flag information 620, and temporary use/storage information 625. In other words, smart contract 600 is described by entity ENT to mint NFT 605 including such information.

Token ID information 610 is used for identification of NFT 605. Tangible object information 612 indicates identification information of the tangible object (in this example, an identification number of vehicle 30) associated with NFT 605.

Holder information 615 indicates the holder of NFT 605. In this example, at the time of minting of NFT 605, the NFT holder is entity ENT which is a minter thereof. As a result of sales through the marketplace, however, the NFT holder is subsequently changed from entity ENT to user U1. Holder information 615 is rewritten in response to transfer (buying and selling) of NFT 605. The NFT holder is changed in connection with rewrite of holder information 615.

Transfer flag information 620 indicates whether transfer of NFT 605 is permitted or prohibited. Specifically, transfer flag information 620 includes a flag that can be switched to one of 0 (off) and 1 (on) by smart contract 600. Switching of the flag from 0 to 1 is also expressed as “turn-on of the flag.” Switching of the flag from 1 to 0 is also expressed as “turn-off of the flag.” When the flag is turned on or off, transfer flag information 620 is rewritten to indicate the latest flag.

Only the NFT holder is allowed to set prohibition (on of the flag) of transfer of NFT 605. At the time of minting of NFT 605, the flag has been set to 0 and transfer of NFT 605 is permitted. User U1 transmits, for example, transaction data to turn on the flag to PBB-NW 60 with the use of user terminal 40. When this transaction data is approved by each node on PBB-NW 60, it is registered in the distributed ledger in the node. Thus, even when transaction data for transfer of NFT 605 is transmitted to PBB-NW 60, this transaction data is not approved on PBB-NW 60 and NFT 605 is not transferred. Each of entity server 10, user terminal 40, and market server 50 can determine whether or not the transaction data indicating on of the flag has been registered in the distributed ledger, by referring to the distributed ledger in PBB-NW 60. Each of them can determine whether transfer of NFT 605 is permitted or prohibited based on a result of this determination.

Temporary use/storage information 625 indicates whether vehicle 30 is being temporarily used by user U1 or stored at dealer DLR. Specifically, temporary use/storage information 625 is set to one of “temporary use” indicating temporary use of vehicle 30 or “storage” indicating storage of vehicle 30. Temporary use/storage information 625 is rewritten from “temporary use” to “storage” in response to completion of temporary use of vehicle 30. How to determine completion of temporary use will be described later in detail.

Holder information 615, transfer flag information 620, and temporary use/storage information 625 are based on a state database (which will be described later) and such information is rewritten in connection with update of the state database.

PRB-NW 70 is a distributed ledger network accessible by each of entity server 10, user terminal 40, and market server 50 similarly to PBB-NW 60. PRB-NW 70 is operated by entity ENT.

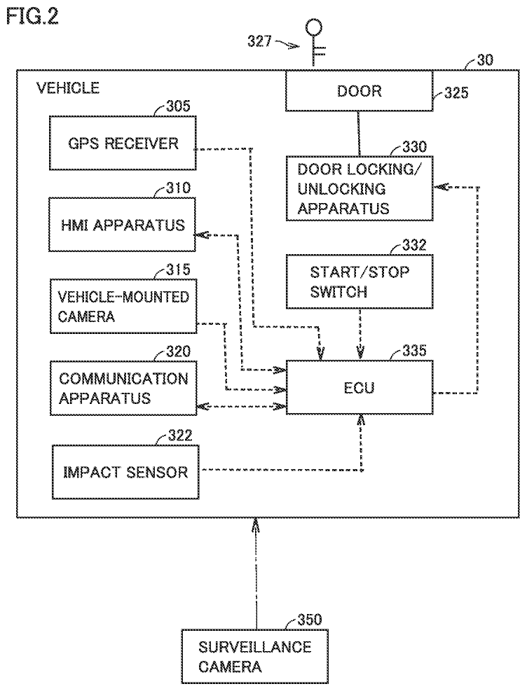

FIG. 2 is a diagram showing a configuration of vehicle 30. Referring to FIG. 2, vehicle 30 includes a GPS receiver 305, an HMI apparatus 310, a vehicle-mounted camera 315, a communication apparatus 320, and an impact sensor 322. Vehicle 30 further includes a door 325, a door locking/unlocking apparatus 330, a start/stop switch 332, and an electronic control unit (ECU) 335.

GPS receiver 305 detects a current position of vehicle 30. HMI apparatus 310 receives input of various user operations such as an operation for input of the reservation information described previously and shows various screens. Vehicle-mounted camera 315 shoots an image of surroundings of vehicle 30. An image shot by vehicle-mounted camera 315 is also expressed as a “shot image.” The shot image is used for guaranteeing that an external object has not collided against vehicle 30 while vehicle 30 is brought out of the garage of dealer DLR and driven. The shot image may be still images or moving images.

Communication apparatus 320 is configured to establish short-range communication with user terminal 40 or communicate with entity server 10. This short-range communication allows activation of user terminal 40 as a smart key that locks/unlocks door 325 or allows user terminal 40 to function as a remote controller that turns on/off start/stop switch 332. For example, while door 325 is locked, unless the smart key function of user terminal 40 is deactivated, communication apparatus 320 can receive a door unlocking request for unlocking door 325 from user terminal 40. Door 325 can thus be unlocked. Communication apparatus 320 transmits position information indicating the position of vehicle 30 to entity server 10 and dealer server or sequentially transmit images shot during travel of vehicle 30 to entity server 10 and dealer server 20. Impact sensor 322 detects an impact applied to vehicle 30 by an external object. A detection value from impact sensor 322 represents magnitude of the impact.

Door locking/unlocking apparatus 330 is mechanically coupled to door 325 and configured to lock or unlock door 325. Activation and deactivation of the remote controller function and the smart key function of user terminal 40 are set in accordance with an activation instruction and a deactivation instruction transmitted from entity server 10 to user terminal 40, respectively. Door 325 may be unlocked by a physical key 327. Physical key 327 is stored at dealer DLR and handed over to user U1 from employee EMP before temporary use of vehicle 30.

Start/stop switch 332 is operated for switching between start-up and shutdown of a travel system of vehicle 30. Start/stop switch 332 may be turned on/off through short-range communication with the use of user terminal 40.

ECU 335 obtains information indicating a position detected by GPS receiver 305 (position information of vehicle 30), an image shot by vehicle-mounted camera 315, a result of detection by impact sensor 322, and a signal indicating on/off of start/stop switch 332. ECU 335 controls various devices of vehicle 30 such as HMI apparatus 310, communication apparatus 320, and door locking/unlocking apparatus 330.

ECU 335 determines whether or not vehicle 30 has collided against an external object in accordance with whether or not impact sensor 322 has detected the impact. ECU 335 transmits to entity server 10 through communication apparatus 320, a result of determination and collision/non-collision information representing the detection value from impact sensor 322 when the impact is detected.

When communication apparatus 320 receives the door unlocking request described previously while door 325 is locked, ECU 335 controls door locking/unlocking apparatus 330 to unlock door 325.

In this example, vehicle 30 is stored in the garage of dealer DLR and vehicle 30 and the surroundings are monitored by a surveillance camera 350 provided in the garage. An image (surveillance image) generated by surveillance camera 350 is transmitted to dealer server 20 by a communication apparatus (not shown) connected to surveillance camera 350, and thereafter transmitted to entity server 10. The surveillance image may be still images or moving images.

In the description below, during a period of storage of vehicle 30 at dealer DLR, the remote controller function and the smart key function of user terminal 40 are assumed as being inactive until user terminal 40 receives the activation instruction described previously.

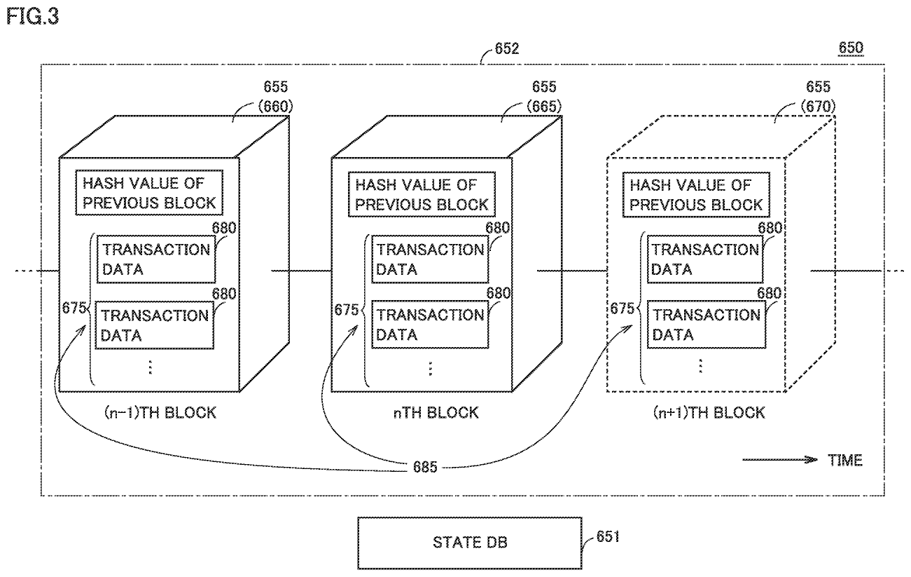

FIG. 3 is a diagram illustrating a data structure of a distributed ledger stored in each node on PBB-NW 60. Referring to FIG. 3, a distributed ledger 650 includes a state database 651 and a blockchain 652.

State database 651 represents a latest state (for example, the NFT holder, permission/prohibition of transfer of NFT 605, and temporary use/storage of vehicle 30 at the current time point) of distributed ledger 650.

Blockchain 652 includes a plurality of blocks 655 (blocks 660, 665, and 670 in this example). Each of blocks 655 includes a hash value of a previous block and a data set 675. Data set 675 includes a large number of pieces of transaction data 680. Transaction data 680 may be transaction data on NFT 605. Data composed of a plurality of data sets 675 is also expressed as a transaction history 685.

New block 670 (an (n+1)th block in the figure) includes unapproved transaction data 680. New block 670 is approved (finalized) by mining processing and thereafter added to distributed ledger 650. Transaction data 680 in new block 670 is thus registered in distributed ledger 650 and activated. Such registration of transaction data 680 in distributed ledger 650 corresponds to addition of new block 670 including this transaction data 680 to distributed ledger 650. A consensus algorithm for mining processing includes proof of work (PoW), proof of stake (PoS), or practical Byzantine fault tolerance (PBFT).

When transaction data 680 indicating the new NFT holder is registered, state database 651 is updated to indicate the new NFT holder. When transaction data 680 indicating turn-on of the flag (prohibition of transfer of NFT 605) is registered, state database 651 is updated to indicate turn-on of the flag. When transaction data 680 indicating completion of temporary use is registered, state database 651 is updated to indicate completion of temporary use.

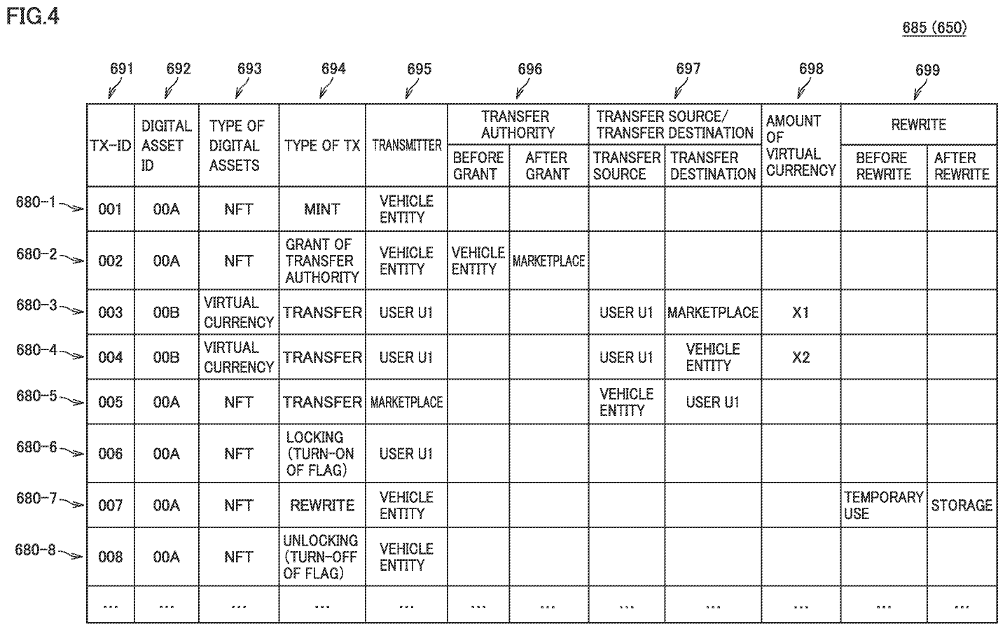

FIG. 4 is a diagram schematically showing a data structure of transaction history 685. Referring to FIG. 4, transaction history 685 includes a plurality of pieces of transaction data 680 (transaction data 680-1 to transaction data 680-8 in this example). Transaction data 680-1 to transaction data 680-8 are registered in this order in distributed ledger 650.

Transaction data 680 includes transaction (TX) ID information 691, digital asset ID information 692, digital asset type information 693, and transaction type information 694. Transaction data 680 further includes transmitter information 695, transfer authority information 696, transfer source/transfer destination information 697, virtual currency amount information 698, and rewrite information 699.

Transaction ID information 691 indicates identification information of a corresponding transaction. Digital asset ID information 692 indicates identification information of digital assets relating to corresponding transaction data 680. Digital asset type information 693 indicates a type of corresponding digital assets.

Transaction type information 694 indicates a type of a corresponding transaction. Transmitter information 695 is information indicating a user who has transmitted corresponding transaction data 680 to PBB-NW 60 (specifically, an ID of this user).

Transfer authority information 696 indicates an entity that has the authority to transfer corresponding digital assets over a period around grant of the authority when transaction type information 694 indicates “grant of transfer authority.” Otherwise, transfer authority information 696 is left blank.

Transfer source/transfer destination information 697 indicates a transfer source and a transfer destination of the digital assets when transaction type information 694 indicates “transfer”. Otherwise, transfer source/transfer destination information 697 is left blank.

Virtual currency amount information 698 indicates an amount of virtual currency sent from a remittance source to a remittance destination of the virtual currency when digital asset type information 693 indicates the “virtual currency” and transaction type information 694 indicates “transfer”. Otherwise, virtual currency amount information 698 is left blank.

Rewrite information 699 indicates information to be rewritten over a period around rewrite when transaction type information 694 indicates “rewrite”. In this example, information to be rewritten is information indicating whether vehicle 30 is being temporarily used or stored. Rewrite information 699 is included in transaction data 680 (680-7) for rewrite of the information to be rewritten from “temporary use” to “storage”. When transaction type information 694 is different from “rewrite”, rewrite information 699 is left blank. When transaction data 680-7 is registered, the information to be rewritten is rewritten from “temporary use” to “storage” and hence transaction data 680-8 indicates completion of temporary use of vehicle 30.

Referring again to FIG. 1, NFT 605, as being associated with vehicle 30, may be used as a certificate to certify the right to temporarily use vehicle 30. When NFT 605 is stored in wallet 505-1, user U1 is assumed to become the NFT holder and to acquire the right to temporarily use vehicle 30. Thereafter, when user U1 transmits temporary use request TU-RQ to entity server 10, dealer DLR makes arrangement for vehicle 30. Consequently, user U1 can temporarily use vehicle 30.

In this case, when NFT 605 is transferred (sold) through the marketplace from user U1 to user U2 during use of vehicle 30, NFT 605 is given to user U2 whereas user U1 is able to use vehicle 30. Therefore, such a problem that user U1 is unduly able to use vehicle 30 in spite of non-possession of NFT 605 or user U2 is unable to use vehicle 30 in spite of possession of NFT 605 arises. Consequently, since the NFT holder does not necessarily agree with the temporary user of vehicle 30, the temporary user of vehicle 30 may not appropriately be determined based on NFT 605.

Entity server 10 according to the embodiment is configured to address the problem as above. Specifically, when communication apparatus 110 receives temporary use request TU-RQ, processor 115 performs locking processing for locking NFT 605. The locking processing corresponds to processing for prohibiting transfer of NFT 605 from wallet 505 of the NFT holder to another wallet 505.

According to the locking processing, NFT 605 is locked in wallet 505-1 in response to temporary use request TU-RQ. Transfer of NFT 605 is thus prohibited and becomes impossible. Consequently, such a situation as transfer of NFT 605 through the marketplace from user U1 to user U2 during temporary use of vehicle 30 can be prevented.

Specifically, the locking processing is request processing for requesting user terminal 40 of user U1 to prohibit transfer of NFT 605 from wallet 505 of the NFT holder to another wallet 505.

As described previously, prohibition of transfer of NFT 605 can be set only by user U1 who is the NFT holder. When user terminal 40 is requested to prohibit transfer of NFT 605 as above, user U1 can be invited to prohibit transfer of NFT 605 (to lock NFT 605 in wallet 505-1). Transfer of NFT 605 is thus prohibited through smart contract 600 in response to the user operation. Consequently, transfer of NFT 605 during temporary use of vehicle 30 can be avoided.

Specifically, the request processing described previously is processing for requesting user terminal 40 to generate transaction data including smart contract 600 that defines processing for switching the flag set to 0 to the value 1 (processing for turning on the flag). In response to this request, user terminal 40 (user U1) generates transaction data 680 to turn on the flag and transmits the transaction data to PBB-NW 60. Turn-on of the flag is thus approved by PBB-NW 60. Consequently, transfer of NFT 605 is prohibited.

Locking of NFT 605 continues until a temporary use completion condition indicating completion of temporary use of vehicle 30 is satisfied. Transfer of NFT 605 during temporary use of vehicle 30 can thus reliably be prevented. Consequently, disagreement between the NFT holder and the temporary user of vehicle 30 during temporary use of vehicle 30 is avoided. Therefore, the temporary user of vehicle 30 can appropriately be determined based on NFT 605.

The temporary use completion condition is, for example, registration of transaction data 680 indicating completion of temporary use of vehicle 30 in distributed ledger 650. As described previously, tampering of transaction data 680 is less likely once it is registered in distributed ledger 650. Therefore, when such transaction data 680 indicates completion of temporary use of vehicle 30, completion of temporary use of vehicle 30 is highly reliable. Therefore, when the temporary use completion condition is defined as described above, entity server 10 can appropriately make determination as to completion of temporary use of vehicle 30.

The temporary use completion condition may be reception by communication apparatus 110, of a temporary use completion notification indicating completion of temporary use of vehicle 30 from portable terminal 25 or user terminal 40. Employee EMP or user U1 may thus notify entity server 10 of completion of temporary use.

The temporary use completion condition may be defined as a condition that is satisfied when a first condition or a second condition below is satisfied.

The first condition is return of a position of vehicle 30 detected by a position detector to a location of start of temporary use. This location is, for example, a parking space in the garage of dealer DLR. GPS receiver 305 or 450 may implement the position detector.

The second condition is a key return completion condition indicating completion of return of physical key 327 from user U1 to dealer DLR. The key return completion condition may be registration of transaction data 680 indicating completion of return of physical key 327 in distributed ledger 650 or reception by communication apparatus 110, of a key return completion notification indicating completion of return of physical key 327 from dealer server 20 or user terminal 40. In the key return completion condition, return of the electronic key described previously may substitute for return of physical key 327.

When the temporary use completion condition is defined based on the first or second condition as above, entity server 10 can accurately make determination as to completion of temporary use of vehicle 30.

When the temporary use completion condition is satisfied, in embodiments, entity server 10 (processor 115) performs processing for rewriting temporary use/storage information 625 such that temporary use/storage information 625 indicates completion of temporary use of vehicle 30. Specifically, this processing corresponds to transmission to PBB-NW 60, of transaction data 680 for rewrite of the previously-described information to be rewritten from “temporary use” to “storage”. This transaction data 680 is approved by each node on PBB-NW 60 and registered in distributed ledger 650. State database 651 is thus updated to indicate completion of temporary use of vehicle 30. Temporary use/storage information 625 is then rewritten.

Entity server 10 (processor 115) may perform temporary use permission processing for permitting temporary use of vehicle 30 when a locking completion condition indicating completion of locking of NFT 30 is satisfied after the locking processing. Completion of locking of NFT 30 corresponds to switching of the flag from 0 to 1.

When the temporary use permission processing is performed as above, temporary use of vehicle 30 is permitted after completion of locking of NFT 605. A situation that a person different from user U1 unduly uses vehicle 30 before completion of locking of NFT 605 can thus be avoided. Consequently, user U1 can more reliably temporarily use vehicle 30.

The temporary use permission processing is defined to include permission of unlocking of door 325 or permission of start-up of the travel system of vehicle 30. Permission of unlocking of door 325 may be activation of the smart key function of portable terminal 25 (including transmission of the electronic key for unlocking of door 325 to user terminal 40) or an instruction through dealer server 20 and portable terminal 25 to employee EMP to hand over physical key 327 to user U1. Permission of start-up of the travel system corresponds to activation of the remote controller function of portable terminal 25 for permission of start-up (turn-on of start/stop switch 332) of the travel system.

The locking completion condition is, for example, registration of transaction data 680 indicating completion of locking of NFT 605 (switching of the flag from 0 to 1) in distributed ledger 650. When transaction data 680 indicates completion of locking of NFT 605, completion of locking of NFT 605 is highly reliable. Such transaction data 680 is transmitted by user terminal 40 (user U1) to PBB-NW 60.

Entity server 10 can sequentially refer to distributed ledger 650 including finalized block 655. Entity server 10 can thus determine whether or not transaction data 680 indicating completion of locking of NFT 605 has been registered, and appropriately determine whether or not the locking completion condition has been satisfied in accordance with a result of the determination.

The locking completion condition may be reception by entity server 10 (communication apparatus 110) from user terminal 40, of a locking completion notification indicating completion of locking of NFT 605. In this case, user U1 transmits to PBB-NW 60, transaction data 680 indicating completion of locking of NFT 605 with the use of user terminal 40, and thereafter transmits the locking completion notification to entity server 10 with the use of user terminal 40.

After the temporary use completion condition is satisfied, entity server 10 performs unlocking processing for unlocking NFT 605. The unlocking processing corresponds to processing for requesting user terminal 40 to generate transaction data 680 including smart contract 600 that defines processing for switching the flag set to 1 to 0 (processing for turning off the flag) and to transmit the transaction data to PBB-NW 60. Since the flag is switched from 1 to 0 in the unlocking processing, transfer (distribution) of NFT 605 is again permitted in response to completion of temporary use of vehicle 30. Convenience of user U1 can thus be improved.

A period during which vehicle 30 is temporarily used is also expressed as a “temporary use period.” Entity server 10 performs temporary use record registration processing for registering on the distributed ledger network (specifically, in the distributed ledger thereof), a temporary use record indicating a record of temporary use of vehicle 30 during the temporary use period. The temporary use record is, for example, a record of travel of vehicle 30 during the temporary use period, and created for guaranteeing that an external object has not collided against vehicle 30 during the temporary use period. This record of travel may be position information of vehicle 30, impact/non-collision information, or information representing a shot image.

When the temporary use record is registered, any device that can access the distributed ledger network can check how vehicle 30 was temporarily used during the temporary use period, by referring to the distributed ledger on this network. In the embodiment, the distributed ledger network in which the temporary use record is registered is not PBB-NW 60 where NFT 605 is minted but PRB-NW 70 operated by entity ENT. Increase in amount of data recorded on PBB-NW 60 can thus be prevented.

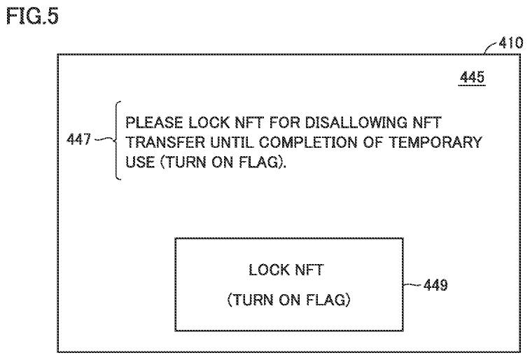

FIG. 5 is a diagram exemplifying a screen shown on HMI apparatus 410 of user terminal 40 in response to the locking processing. Referring to FIG. 5, a screen 445 includes a message 447 and a button 449. While screen 445 is shown, transfer of the NFT is permitted (the flag has been set to 0).

Message 447 invites user U1 to lock NFT 605 (turn on the flag). Button 449 is operated by user U1 for locking NFT 605 in wallet 505-1. When button 449 is operated, user terminal 40 transmits transaction data 680 indicating locking of NFT 605 to PBB-NW 60. Thereafter, this transaction data 680 is approved and registered in distributed ledger 650.

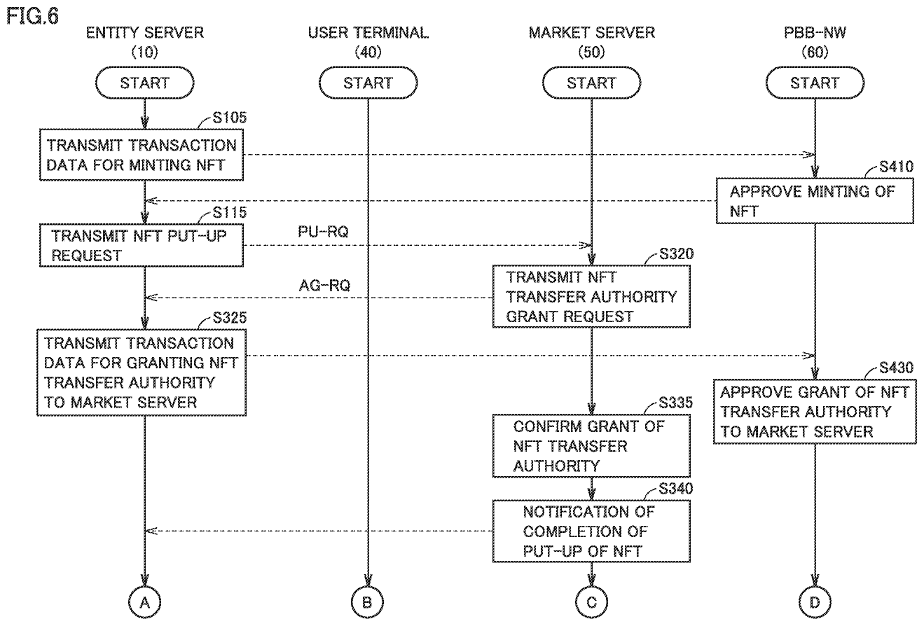

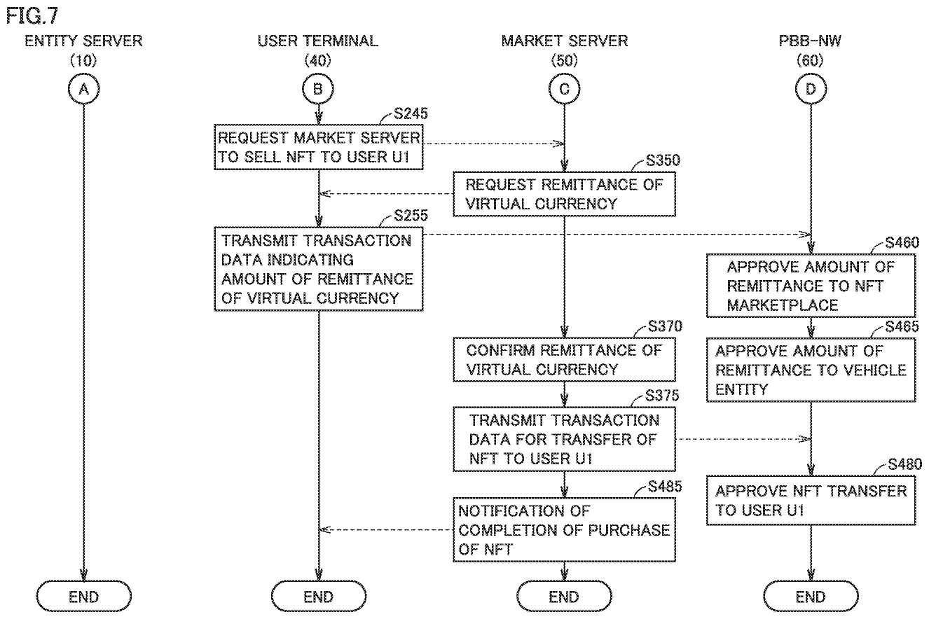

FIGS. 6 and 7 are each a flowchart exemplifying processing performed in connection with minting and sales of NFT 605. A step will be abbreviated as “S” below.

Referring to FIG. 6, entity server 10 transmits transaction data 680 for minting NFT 605 to PBB-NW 60 (S105). Each node on PBB-NW 60 thus approves minting of NFT 605 (S410). Specifically, transaction data 680-1 (FIG. 4) is registered in distributed ledger 650 in each node on PBB-NW 60. Entity ENT is thus approved as the minter (the first NFT holder) of NFT 605.

When entity server 10 confirms registration of transaction data 680-1, it transmits an NFT 605 put-up request PU-RQ to market server 50 (S115). Put-up request PU-RQ is generated to request market server 50 to put up NFT 605 on the marketplace.

Market server 50 transmits an NFT transfer authority grant request AG-RQ to entity server 10 in response to reception of put-up request PU-RQ (S320). NFT transfer authority grant request AG-RQ is generated for requesting entity server 10 to grant the NFT transfer authority originally of entity server 10 to market server 50.

Entity server 10 transmits to PBB-NW 60, transaction data 680 for granting the NFT transfer authority to market server 50 in response to reception of NFT transfer authority grant request AG-RQ (S325).

Each node on PBB-NW 60 approves grant of the NFT transfer authority to market server 50 (S430). Specifically, transaction data 680-2 is registered in distributed ledger 650 in each node on PBB-NW 60. Market server 50 thus acquires the NFT transfer authority.

Market server 50 confirms registration on PBB-NW 60, of transaction data 680 indicating grant of the NFT transfer authority, by referring to distributed ledger 650 after S430 (S335). Market server 50 then performs processing for putting up NFT 605 on the marketplace. Thereafter, entity server 10 is notified of completion of put-up of NFT 605 (S340).

Referring to FIG. 7, user terminal 40 requests market server 50 to sell NFT 605 put up on the marketplace to user U1 (a person who desires to purchase the NFT) (S245). Market server 50 requests user terminal 40 to remit the virtual currency such that a price for NFT 605 is paid in virtual currency (S350).

User terminal 40 transmits transaction data 680 indicating an amount of remittance of the virtual currency to PBB-NW 60 (S255). This amount of remittance includes an amount of remittance (a first amount of remittance) to a marketplace operator and an amount of remittance (a second amount of remittance) to entity ENT. The first amount of remittance corresponds to the amount of virtual currency paid as a commission fee to the marketplace operator. The second amount of remittance corresponds to the amount of virtual currency paid by user U1 to entity ENT for purchase of NFT 605.

Each node on PBB-NW 60 approves the first amount of remittance (S460). Specifically, transaction data 680-3 is registered in distributed ledger 650 in each node on PBB-NW 60. The first amount of remittance is put into wallet 505 of the marketplace operator.

Each node on PBB-NW 60 approves the second amount of remittance (S465). Specifically, transaction data 680-4 is registered in distributed ledger 650 in each node on PBB-NW 60. The second amount of remittance is thus put into wallet 505 of entity ENT.

Market server 50 confirms approval of remittance of the virtual currency to each of the marketplace and entity ENT by referring to distributed ledger 650 after S465 (S370). Market server 50 then transmits to PBB-NW 60, transaction data 680 for transfer of NFT 605 from entity ENT which is the NFT minter to user U1 who has purchased the NFT (S375).

Each node on PBB-NW 60 approves transfer of the NFT from entity ENT to user U1 (S480). Specifically, transaction data 680-5 is registered in distributed ledger 650 in each node on PBB-NW 60. NFT 605 is then stored in wallet 505-1.

Market server 50 confirms approval of transfer of the NFT to user U1 (purchase of NFT 605 by user U1) by referring to distributed ledger 650 after S480. Market server 50 then notifies user terminal 40 of completion of purchase of NFT 605 by user U1 (S485). The process thereafter ends.

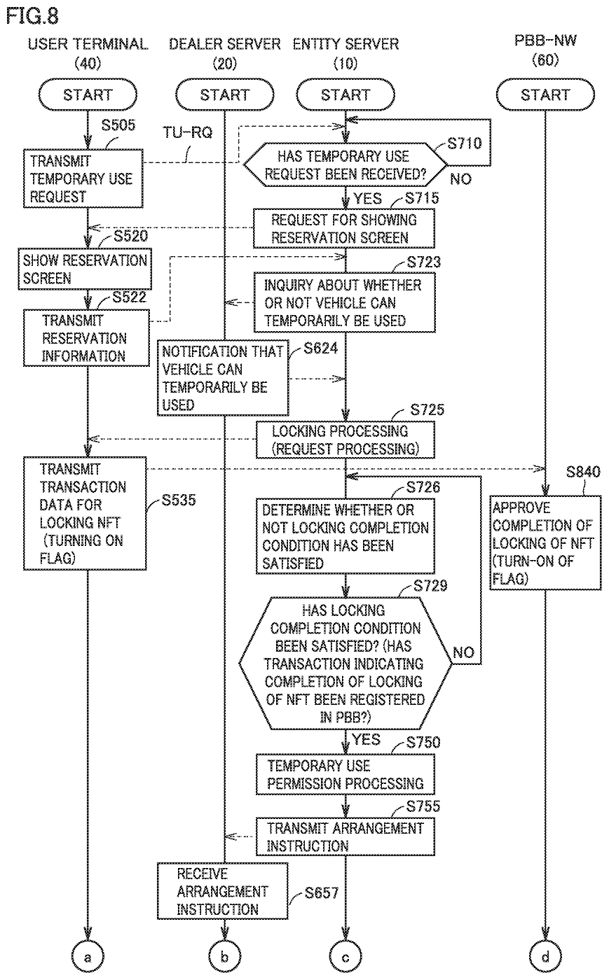

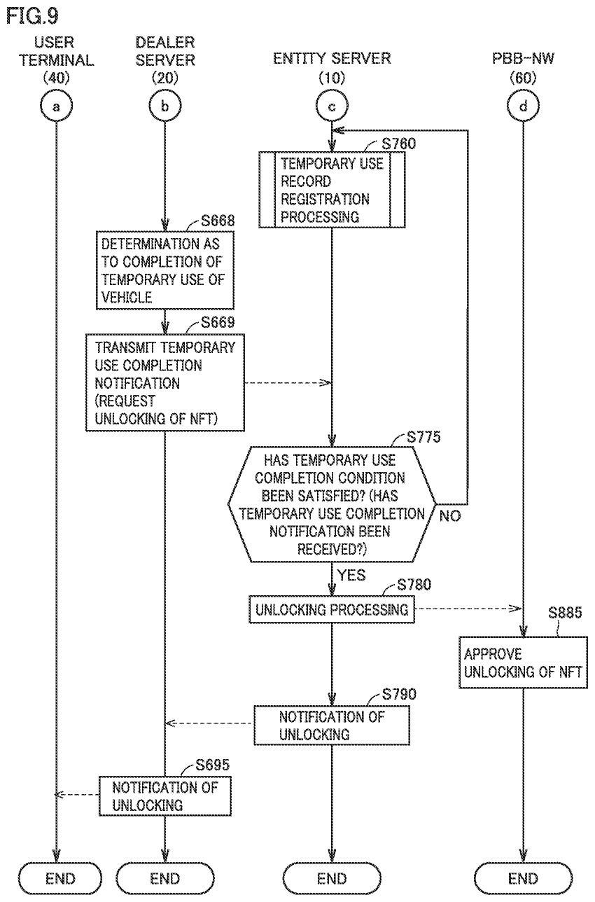

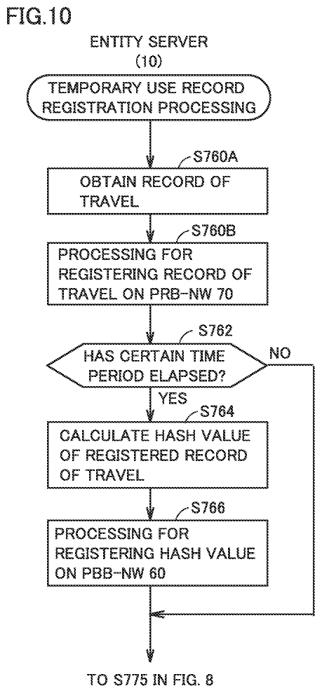

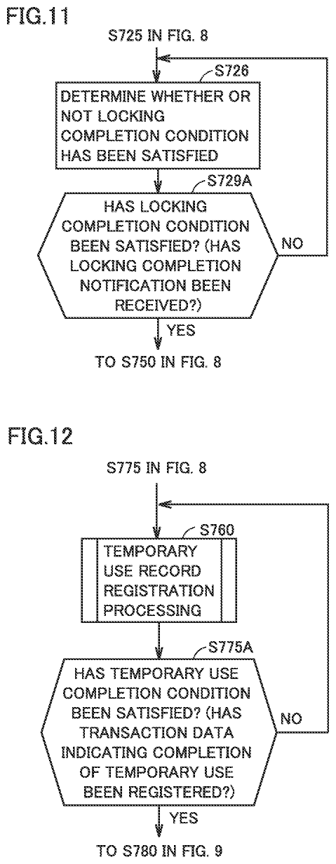

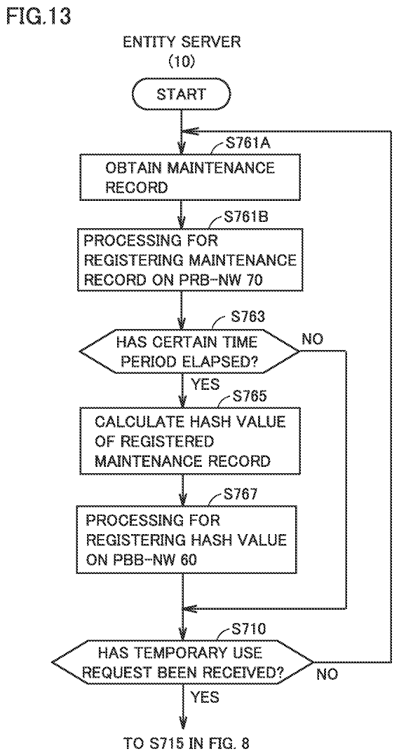

FIGS. 8 and 9 are each a flowchart exemplifying processing performed in connection with temporary use of vehicle 30 by user U1. This flowchart is started when user U1 performs the temporary use request operation described previously.

Referring to FIG. 8, user terminal 40 transmits temporary use request TU-RQ to entity server 10 (S505). Entity server 10 determines whether or not it has received temporary use request TU-RQ (S710). When entity server 10 has not yet received temporary use request TU-RQ (NO in S710), it performs S710 until it receives temporary use request TU-RQ. When entity server 10 has received temporary use request TU-RQ (YES in S710), the process proceeds to S715. Entity server 10 requests user terminal 40 to show the reservation screen described previously (S715).

User terminal 40 shows the reservation screen (S520), and receives input of the reservation information through the reservation screen from user U1. User terminal then transmits the reservation information to entity server 10 (S522).

Entity server 10 asks dealer server 20 whether or not vehicle 30 can temporarily be used in response to reception of the reservation information (S723). Dealer server notifies entity server 10 that vehicle 30 can temporarily be used (S624). Entity server 10 performs the locking processing (request processing) in response to this notification (S725).

User terminal 40 shows screen 445 (FIG. 5) on HMI apparatus 410 in response to the locking processing. In this example, button 449 is operated by user U1. User terminal 40 then transmits transaction data 680 for locking NFT 605 (for turning on the flag) to PBB-NW 60 in response to this user operation (S535).

Each node on PBB-NW 60 approves locking of NFT 605 (turn-on of the flag) (S840). Specifically, transaction data 680-6 is registered in distributed ledger 650 in each node on PBB-NW 60. NFT 605 is thus locked and transfer thereof is prohibited.

Entity server 10 performs processing for determining whether or not the locking completion condition has been satisfied (S726). In this example, the locking completion condition is registration of transaction data 680 (680-6) indicating completion of locking of NFT 605 in distributed ledger 650.

Entity server 10 switches processing in accordance with whether or not the locking completion condition has been satisfied (S729). Specifically, entity server 10 switches processing in accordance with whether or not transaction data 680-6 has been registered on PBB-NW 60.

When the locking completion condition has not been satisfied (NO in S729), the process returns to S726. When the locking completion condition has been satisfied (YES in S729), entity server 10 performs the temporary use permission processing described previously (S750). Entity server 10 then transmits arrangement instruction AR-IN to dealer server 20 (S755). Dealer server 20 receives arrangement instruction AR-IN (S657) and instructs employee EMP to make arrangements for vehicle 30. Thereafter, temporary use of vehicle 30 by user U1 is started and vehicle 30 starts to travel.

Referring to FIG. 9, entity server 10 performs temporary use record registration processing (S760). As will be described in detail below, this registration processing includes processing for registering a record of travel of vehicle 30 during the temporary use period in PRB-NW 70.

FIG. 10 is a flowchart showing a specific procedure in the temporary use record registration processing. Referring to FIG. 10, entity server 10 obtains from vehicle 30, a record of travel of vehicle 30 during the temporary use period (S760A). This record of travel includes position information of vehicle 30, collision/non-collision information, and information representing an image picked up by vehicle-mounted camera 315.

Entity server 10 performs processing for registering the record of travel on PRB-NW 70 (S760B). Specifically, entity server 10 transmits to PRB-NW 70, transaction data for registering the record of travel in PRB-NW 70. This transaction data is thus approved and registered on PRB-NW 70.

Entity server 10 determines whether or not a prescribed time period has elapsed since S766 which will be described later was previously performed (S762). This time period is determined in advance as appropriate by entity ENT. When this time period has not yet elapsed (NO in S762), the process proceeds to S775. When this time period has elapsed (YES in S762), the process proceeds to S764.

Entity server 10 calculates a hash value of the record of travel registered on PRB-NW 70 (S764). Entity server 10 performs processing for registering the hash value on PBB-NW 60 (S766). Specifically, entity server 10 transmits to PBB-NW 60, transaction data 680 for registering the hash value on PBB-NW 60 as a snapshot. Thereafter, the process proceeds to S775. Each node on PBB-NW 60 approves the hash value, and the hash value is registered as the snapshot therein.

Referring again to FIG. 9, dealer server 20 determines, for example, that vehicle has returned to the parking space in the garage of dealer DLR, in accordance with the position information of vehicle 30 and makes determination as to completion of temporary use of vehicle 30 based on this determination (S668). Dealer server 20 then transmits the temporary use completion notification indicating completion of temporary use of vehicle 30 to entity server 10 (S669). S669 corresponds to processing for requesting entity server 10 to unlock NFT 605.

After S760, entity server 10 determines whether or not the temporary use completion condition has been satisfied (S775). In this example, the temporary use completion condition is reception by entity server 10, of the temporary use completion notification from portable terminal 25.

Unless the temporary use completion condition is satisfied (NO in S775), the process returns to S760. Entity server 10 thus performs again S760A and S760B (FIG. 11), and each time the time period described previously elapses (YES in S762), entity server 10 performs again S764 and S766. As this time period is shorter, the snapshot of the record of travel is higher in granularity. Consequently, traceability of the record of travel on PBB-NW 60 can be improved.

When the temporary use completion condition has been satisfied (YES in S775), entity server 10 performs the unlocking processing (S780). Specifically, entity server 10 transmits transaction data 680 for unlocking NFT 605 (turning off the flag) to PBB-NW 60. Thereafter, each node on PBB-NW 60 approves unlocking of NFT 605 (S885). Specifically, transaction data 680-8 indicating unlocking (turn-off of the flag) is registered in distributed ledger 650 in each node on PBB-NW 60.

Entity server 10 confirms unlocking of NFT 605 by referring to distributed ledger 650 after S885. Entity server 10 then notifies dealer server 20 of unlocking of NFT 605 (S790). Dealer server 20 notifies user terminal 40 of unlocking of NFT 605. The process thereafter ends.

Entity server 10 may determine whether or not the locking completion condition has been satisfied in a manner different from S729 in FIG. 8.

FIG. 11 is a flowchart exemplifying processing performed by entity server 10 instead of S729 in FIG. 8. Referring to FIG. 11, after S725 and 726, entity server 10 determines whether or not the locking completion condition has been satisfied in accordance with whether or not it has received the locking completion notification described previously (S729A). When entity server 10 has not yet received the locking completion notification (NO in S729A), the process returns to S726. When entity server 10 has received the locking completion notification (YES in S729A), the process proceeds to S750.

Entity server 10 may determine whether or not the temporary use completion condition has been satisfied in a manner different from S775 in FIG. 9.

FIG. 12 is a flowchart exemplifying processing performed by entity server 10 instead of S775 in FIG. 9. Referring to FIG. 12, after S760, entity server 10 determines whether or not the temporary use completion condition has been satisfied in accordance with whether or not transaction data 680 (680-7) indicating completion of temporary use of vehicle 30 has been registered in distributed ledger 650 (S775A). When transaction data 680-7 has not yet been registered (NO in S775A), the process returns to S760. When transaction data 680-7 has been registered (YES in S775A), the process proceeds to S780.

As set forth above, when entity server 10 receives temporary use request TU-RQ, it performs the locking processing (request processing) for locking NFT 605. A situation that NFT 605 is transferred (sold) through the marketplace from user U1 to user U2 during temporary use of vehicle 30 can thus be prevented.

[Modification]

During a period different from the temporary use period, vehicle 30 is stored in the garage of dealer DLR. The period during which vehicle 30 is stored is also expressed as a “storage period.” In this modification, entity server 10 performs storage record registration processing for registering a storage record representing a record of storage of vehicle 30 during the storage period on the distributed ledger network (specifically, in the distributed ledger thereof). The storage record is, for example, a maintenance record of vehicle 30 during the storage period and created by employee EMP with the use of portable terminal 25. The storage record is created for guaranteeing that an external object has not collided against vehicle 30 during the storage period, and it is stored, for example, in dealer server 20. The storage record may be surveillance images obtained by surveillance camera 350.

When the storage record is registered, any device that can access the distributed ledger network can confirm how vehicle 30 has been stored during the storage period by referring to the distributed ledger on this network. In this modification, the distributed ledger network where the storage record is registered is not PBB-NW 60 where NFT 605 is minted but PRB-NW 70 operated by entity ENT. Increase in amount of data recorded on PBB-NW 60 can thus be prevented.

FIG. 13 is a flowchart exemplifying storage record registration processing performed by entity server 10. This flowchart is started after S790 in FIG. 9.

Referring to FIG. 13, entity server 10 obtains the storage record of vehicle 30 during the storage period from dealer server 20 (S761A). In this example, the storage record is the maintenance record of vehicle 30.

Entity server 10 performs processing for registering the maintenance record on PRB-NW 70 (S761B). Specifically, entity server 10 transmits transaction data for registering the maintenance record to PRB-NW 70. This transaction data is thus approved by PRB-NW 70 and registered therein.

Entity server 10 determines whether or not a prescribed time period has elapsed since S767 which will be described later was previously performed (S763). When this time period has not yet elapsed (NO in S763), the process proceeds to S710. When this time period has elapsed (YES in S763), the process proceeds to S765.

Entity server 10 calculates the hash value of the maintenance record registered on PRB-NW 70 (S765). Entity server 10 performs processing for registering the hash value on PBB-NW 60 (S767). Specifically, entity server 10 transmits to PBB-NW 60, transaction data 680 for registering the hash value on PBB-NW 60 as the snapshot. Thereafter, the process proceeds to S710. Each node on PBB-NW 60 approves the hash value, and the hash value is registered as the snapshot therein.

Unless entity server 10 receives temporary use request TU-RQ (NO in S710), the process returns to S761A. Entity server 10 thus performs again S761A and S761B, and each time the time period described previously has elapsed (YES in S763), entity server 10 performs again S765 and 767. As this time period is shorter, the snapshot of the storage record is higher in granularity. Consequently, traceability of the storage record on PBB-NW 60 can be improved.

[Other Modifications]

Though wallet 505 is provided in wallet DB 500 of market server 50, it may be provided in a computer different from market server 50.

The record of travel of vehicle 30 during the temporary use period may be registered on PBB-NW 60 instead of PRB-NW 70. Similarly, the maintenance record of vehicle 30 during the storage period may be registered on PBB-NW 60 instead of PRB-NW 70.

So long as PBB-NW 60 is accessible by each of entity server 10, user terminal 40, and market server 50, another type of distributed ledger network such as a private or consortium blockchain may substitute for PBB-NW 60.

Entity server 10 and dealer server 20 may be integrated with each other. In this case, a server composed of entity server 10 and dealer server 20 forms an exemplary “server” in the present disclosure.

A tangible object associated with the NFT is not limited to vehicle 30. Such a tangible object may be another type of tangible object such as a painting, an antique, a precious stone, precious metal, or a movable body including a sea vessel or an aircraft.

### INDUSTRIAL APPLICABILITY

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A server comprising:
a communication apparatus configured to receive a temporary use request that requests temporary use of a tangible object by a holder of a non-fungible token, the tangible object being associated with the non-fungible token; and
a processor that performs locking processing for locking the non-fungible token when the communication apparatus receives the temporary use request.

2. The server according to claim 1, wherein
the locking processing includes request processing for requesting a terminal apparatus of the holder to prohibit transfer of the non-fungible token from a wallet of the holder to another wallet.

3. The server according to claim 2, wherein
the non-fungible token includes a flag that can be switched to one of a first value and a second value by a smart contract,
the smart contract sets the flag to the first value when it permits the transfer and sets the flag to the second value when it prohibits the transfer, and
the request processing includes processing for requesting the terminal apparatus to generate transaction data including the smart contract that defines processing for switching the flag set to the first value to the second value.

4. The server according to claim 3, wherein
locking of the non-fungible token continues until a temporary use completion condition indicating completion of temporary use of the tangible object is satisfied.

5. The server according to claim 4, wherein
the processor is configured to refer to transaction data registered in a distributed ledger, and
the temporary use completion condition includes registration of the transaction data indicating completion of temporary use of the tangible object in the distributed ledger.

6. The server according to claim 4, wherein
the temporary use completion condition includes reception, by the communication apparatus, of a temporary use completion notification indicating completion of temporary use of the tangible object.

7. The server according to claim 4, wherein
the tangible object includes a vehicle,
the temporary use completion condition is satisfied when a first condition or a second condition is satisfied,
the first condition is return of a position of the vehicle detected by a position detector to a location of start of the temporary use, and
the second condition is a key return completion condition indicating completion of return of a key for unlocking of a door of the vehicle.

8. The server according to claim 7, wherein
the processor is configured to refer to transaction data registered in a distributed ledger, and
the key return completion condition includes
registration of the transaction data indicating completion of return of the key in the distributed ledger, or
reception, by the communication apparatus, of a key return completion notification indicating completion of return of the key.

9. The server according to claim 3, wherein
when a locking completion condition indicating switching of the flag from the first value to the second value is satisfied after the locking processing, the processor performs temporary use permission processing for permitting the temporary use.

10. The server according to claim 9, wherein
the processor is configured to refer to transaction data registered in a distributed ledger, and
the locking completion condition includes registration of the transaction data indicating switching of the flag from the first value to the second value in the distributed ledger.

11. The server according to claim 9, wherein
the locking completion condition includes reception, by the communication apparatus, of a locking completion notification indicating switching of the flag from the first value to the second value.

12. The server according to claim 9, wherein
the tangible object includes a vehicle, and
the temporary use permission processing includes permission of unlocking of a door of the vehicle or permission of start-up of a travel system of the vehicle.

13. The server according to claim 4, wherein
after the temporary use completion condition is satisfied, the processor performs unlocking processing for unlocking the non-fungible token.

14. The server according to claim 1, wherein
the tangible object is temporarily used during a first period, and
the processor performs processing for registering on a distributed ledger network, a temporary use record indicating a record of temporary use of the tangible object during the first period.

15. The server according to claim 14, wherein
the tangible object is a vehicle, and
the temporary use record includes a record of travel of the vehicle during the first period.

16. The server according to claim 14, wherein
the distributed ledger network is different from a distributed ledger network where the non-fungible token is minted.

17. The server according to claim 1, wherein
the tangible object is temporarily used during a first period, and the tangible object is stored during a second period different from the first period, and
the processor performs processing for registering on a distributed ledger network, a storage record indicating a record of storage of the tangible object during the second period.

18. The server according to claim 17, wherein
the tangible object is a vehicle, and
the storage record includes a maintenance record of the vehicle during the second period.

19. The server according to claim 17, wherein
the distributed ledger network is different from a distributed ledger network where the non-fungible token is minted.

20. A method comprising:
receiving a temporary use request that requests temporary use of a tangible object by a holder of a non-fungible token, the tangible object being associated with the non-fungible token; and
performing locking processing for locking the non-fungible token in response to the temporary use request.
